(19) United States
(12) Patent Application Publication
(10) Pub. No.: US 2014/0154561 A1
(43) Pub. Date: Jun. 5, 2014

(54) BUTTON CELL WITH A LARGE INTERNAL VOLUME

(71) Applicant: Rolf Brenner, Ellwangen (DE)

(72) Inventor: Rolf Brenner, Ellwangen (DE)

(73) Assignee: Varta Microbattery GmbH, Ellwangen (DE)

(21) Appl. No.: 14/130,585

(22) PCT Filed: May 21, 2012
(86) PCT No.: PCT/EP2012/059376

§ 371 Date: Jan. 2, 2014

(30) Foreign Application Priority Data
Jul. 4, 2011 (DE) 10 2011 078 611.2

(51) Int. Cl. H01M 2/02

(52) U.S. Cl. CPC H01M 2/0222
USPC 429/174; 29/623.2

(57) ABSTRACT

A button cell includes a sealed housing including a cup having a base, a circumferential sleeve, an intermediate region connecting the base and sleeve, and a cut edge, a cover having a base, a circumferential sleeve, and a cut edge, and a seal, wherein the cover is arranged with the cut edge in front into the cup, and the seal between the cup and cover is arranged such that it isolates them from each other, and wherein the sleeve of the cover is divided into a single-walled section and an adjoining circumferential double-walled opening edge with a U-shaped cross-section formed by bending the cut edge of the cover radially outwardly, the sleeve of the cover has a circumferential notch directly below the circumferential double-walled opening edge, in which its external diameter has a minimum value, and the sleeve of the cup has a circumferential protuberance formed by radial drawing-in.

### TECHNICAL FIELD

This disclosure relates to button cells with a leaktight sealed housing consisting of a cell cup, a cell cover, and a seal.

### BACKGROUND

Button cells usually have a housing consisting of two housing halves, a cell cup, and a cell cover. These may be produced, for example, from a deep-drawn sheet of nickel-plated metal as stamped parts. The cell cup normally has positive polarity and the cell cover negative polarity. A wide variety of electrochemical systems, for example, zinc/manganese dioxide, primary and secondary lithium-ion systems, or secondary systems such as nickel/cadmium or nickel/metal hydride can be contained inside the housing.

Button cells are conventionally sealed leaktightly by crimping the edge of the cell cup over the edge of the cell cover in conjunction with a plastic ring arranged between the cell cup and the cell cover and which serves simultaneously as a sealing element and to insulate electrically the cell cup and the cell cover. Button cells of this type are described, for example, in DE 31 13 309.

Alternatively, it is also possible to manufacture button cells in which the cell cup and the cell cover are held together in the axial direction purely by a frictional connection and correspondingly do not have a crimped edge. Button cells of this type and their production are described, for example, in WO 2010/089152 A1 and in DE 10 2009 017 514.8.

The use of a sealing element produced by being deep-drawn from a plastic film is described in DE 196 47 593. A cup-shaped part is drawn from a heated piece of foil by a drawing die and a punch while a vacuum is applied. Polyamides are indicated as preferred plastic materials. Depending on the desired diameter/height ratio, the process can take place in one or more consecutive working steps. The base region of the cup-shaped part produced by deep-drawing is then punched out by a blanking punch and a blanking casing. The sealing element produced in this way is mounted on a cell cover which can then be inserted into a cell cup. Because film seals produced in this way only have very small thicknesses, the capacity of the resulting button cells is optimized. The use of foil seals offers clear advantages over the conventional use of seals consisting of injection-molded parts.

Housing covers having a double-walled opening edge with a U-shaped cross-section formed by bending the cut edge of the cell cover radially outward are described in WO 2007/062838, EP 0 731 516, and U.S. Pat. No. 5,919,586. Housings with such button cell covers have excellent sealing properties and high capacities.

There is nonetheless a need to provide button cells characterized in particular by further improved capacity.

### SUMMARY

I provide a button cell including a leaktightly sealed housing consisting of a cell cup having a base, a circumferential sleeve, an intermediate region connecting the base and the sleeve, and a cut edge at the end, a cell cover having a base, a circumferential sleeve, an intermediate region connecting the base and the sleeve, and a cut edge at the end, and a seal, wherein the cell cover is arranged with the cut edge in front into the cell cup, and the seal between the cell cup and the cell cover is arranged such that it isolates them from each other, and wherein the sleeve of the cell cover is divided into a single-walled section and an adjoining circumferential double-walled opening edge with a U-shaped cross-section formed by bending the cut edge of the cell cover radially outwardly, the sleeve of the cell cover has a circumferential notch directly below the circumferential double-walled opening edge, in which its external diameter has a minimum value, and the sleeve of the cell cup has a circumferential protuberance formed by radial drawing-in which engages in this circumferential notch.

I also provide a method of producing the button cell, wherein the housing of the button cell is formed from a cell cup having a base, a circumferential sleeve, an intermediate region connecting the base and the sleeve, and a cut edge at the end, a cell cover having a base, a circumferential sleeve, an intermediate region connecting the base and the sleeve, and a cut edge at the end, and a seal, by the seal being applied to the sleeve of the cell cover and the cell cover is then inserted with the cut edge in front into the cell cup, wherein the sleeve of the cell cover has a single-walled section and an adjoining circumferential double-walled opening edge with a U-shaped cross-section formed by radially bending the cut edge of the cell cover outwardly and, directly below the double-walled opening edge, a circumferential notch in which its external diameter has a minimum value, and the sleeve of the cell cup has a circumferential protuberance formed by radial drawing-in which engages in this notch when the cell cover is inserted into the cell cup, or such a protuberance is formed by radial drawing-in after the cell cover has been inserted into the cell cup.

### BRIEF DESCRIPTION OF THE DRAWINGS

FIG. 1 shows a partially cutaway view of a button cell 100.

FIG. 2 shows an enlarged portion of the cutaway region in FIG. 1.

My button cells comprise a leaktightly sealed housing consisting of a cell cup, a cell cover, and a seal. The cell cup and the cell cover are joined to each other via the seal. Each of them has a base, a circumferential sleeve, an intermediate region connecting the base and the sleeve, and a cut edge at the end.

The base of the cell cup and the base of the cell cover preferably each have a plane and are preferably circular, but optionally also oval design. The sleeve of the cell cover and the sleeve of the cell cup preferably are described as annular segments of a hollow cylinder with a circular or oval cross-section. Generally, the sleeves of the cell cup and cell cover are oriented orthogonally to the associated base.

The intermediate regions of the cell cup and cell cover preferably comprise the parts of the cell cup and cell cover which are not part of the plane of the respective base, but are not yet part of the associated sleeve. The intermediate regions can have a rounded design, for example, in the form of a shoulder, but can also take the form of a sharp edge.

The cell cup and cell cover are preferably manufactured from metal materials such as nickel-plated steel or sheet metal. Tri-metals, for example, in the order (from outside to in) nickel, steel, and copper are moreover also particularly suited.

The cell cover of the button cell is inserted with the cut edge in front into the cell cup. The seal between the cell cup and the cell cover is thus arranged such that it isolates them from each other.

The seal is preferably a film seal, as described, for example, in DE 196 47 593. Film seals made from a thermoplastic are preferably used. Polyamide or polyetheretherketone are particularly suited as materials. However, this disclosure is not limited to such seals. Conventional seals, in particular those produced by injection molding, can in principle also be used.

When the cell cover is inserted into the cell cup, the sleeves of the cell cover and cell cup overlap and form a circumferential overlapping region. The size of the region or the ratio of the overlapping region to the non-overlapping regions is determined by the respective height of the sleeves of the cell cup and cell cover and by the depth to which the latter is inserted in.

The cell cup and the cell cover form, together with the seal, a housing in which the bases of the cell cup and cell cover are arranged parallel to each other. The distance between the bases defines the height of the button cell, and the connecting straight line through the centers of the bases defines the reference axis (axial direction) along which the cell cover is inserted into the cell cup when the button cell is assembled.

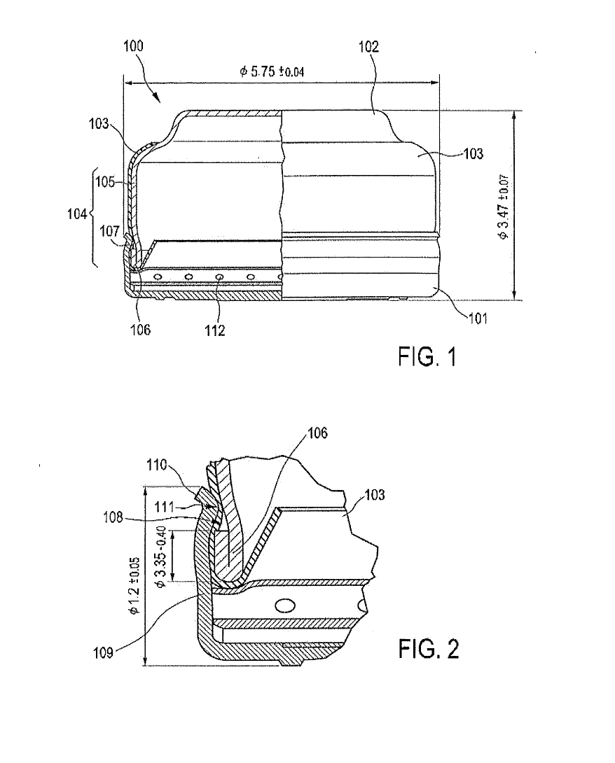

The button cell is particularly distinguished by the sleeve of the cell cover comprising a single-walled section and an adjoining circumferential double-walled opening edge with a U-shaped cross-section formed by bending the cut edge of the cell cover radially outwardly. In other words, the button cell has a button cell cover as is known from WO 2007/062838, EP 0 731 516, and U.S. Pat. No. 5,919,586. In all of those devices, cell covers are described in which, as in the case of currently used cell covers, the bent cut edge of the cell cover abuts the outside of the sleeve of the cell cover. The abutting cut edge forms a small shoulder or projection on the outside of the sleeve of the cell cup. However, if the double-walled opening edge with a U-shaped cross-section is drawn radially inwardly, as shown, for example, in FIG. 1 or 2 of EP 0731516 or FIG. 3a or 3b of U.S. Pat. No. 5,919,586, then the projection or shoulder results in a notch in which the external diameter of the casing of the cell cover has a minimum value.

The button cell also has a cell cover with such a circumferential notch which runs directly below the double-walled opening edge and in which the external diameter of the sleeve of the cell cover has a minimum value. The external diameter of the sleeve of the cell cover preferably has a maximum value in the region of the double-walled opening edge, then decreases when approaching the notch, and increases again below the notch. Or, in other words, the external diameter of the sleeve has a minimum value in the notch and increases again above and below the notch.

It is not known that such a notch can serve to fix the cell cover in the cell cup. For this purpose, the sleeve of the cell cup of my button cells have a circumferential protuberance, formed by being drawn in radially, which engages in this notch. The cell cup and the cell cover of my button cells are thus joined in the axial direction by a positive locking connection without there being an absolute need for the conventional crimping mentioned above.

The cell cup and cell cover can be assembled and locked together much more simply in the case of my button cells than in the case of conventional button cells. There is no need for a complex crimping tool to form the circumferential protuberance and, instead, only a drawing-in bush with a conical profile is needed. During the drawing-in process itself, radial forces are exerted on the cell cover only in the region of the double-walled opening edge with a U-shaped cross-section. In this region the cell cover has a particularly high stability so that there is very little likelihood of the cell being damaged during the final assembly.

Particularly preferably, the protuberance which engages in the notch is formed by the radially drawn-in cut edge of the cell cup. In this case, the sleeve of the cell cup only has a very small height, which entails a considerable saving in material. The radial drawing-in of the cut edge of the cell cup can be effected, for example, with the already mentioned drawing-in bush. The cut edge is preferably drawn in radially after the cell cover has been inserted into the cell cup.

It is likewise possible that the protuberance engaging in the notch may be formed by a radial circumferential indentation, arranged below the cut edge, in the sleeve of the cell cup. In this case, the sleeve of the cell cover is higher than in the abovedescribed embodiment. It is preferred that, when the cell cover is completely inserted into the cell cup, the cut edge situated above the indentation preferably abuts against the outer wall of the sleeve of the cell cover, in particular in the single-walled section, and is not crimped, for example, in the intermediate region of the cell cover.

The radial circumferential indentation can also be effected by the drawing-in bush.

Preferably, the sleeve of the cell cup has a height that is less than 60%, preferably less than 40%, of the height of the button cell.

In the single-walled section, the external diameter of the sleeve of the cell cover does not normally exceed the maximum external diameter of the sleeve of the cell cup and generally is less than it.

Generally, the seal encloses the double-walled opening edge of the cell cover. Preferably, it covers the outside of the sleeve of the cell cover at least partially, preferably completely, and can even be drawn into the intermediate region.

Preferably, the seal can be colored. In the case of a film seal, plastic films containing a color pigment can, for example, be used. The seal can, for example, be colored blue, red, yellow, green, or black. In this way, it is possible to distinguish button cells by color, for example, to differentiate between rechargeable and unrechargeable button cells. A green film can be used, for example, for rechargeable button cells. In conventional button cells, the seal between the parts of the housing, the cell cup and cell cover, cannot be seen, or can barely be seen. A different situation applies when the seal according to the preferred cell covers the sleeve of the cell cover at least partially or even completely.

As mentioned earlier, I provide methods of producing button cells. Cell cups, cell covers, and seals as described above are used in the methods.

In the methods, in one step a seal is applied to the sleeve of a cell cover. The latter comprises, as described above, in addition to the mentioned single-walled section and the adjoining circumferential double-walled opening edge with a U-shaped cross-section beneath the opening edge, a circumferential notch in which its external diameter has a minimum value. In a further step, the cell cover with the applied seal is inserted with the cut edge in front into a cell cup, the sleeve of the cell cup having a circumferential protuberance formed by radial drawing-in which engages into this notch when the cell cover is inserted into the cell cup. Alternatively, this protuberance can also be formed by radial drawing-in after the cell cover has been inserted into the cell cup.

The button cell is preferably a zinc-air button cell. Alternatively, the cell cup, however, also, for example, be a nickel/metal hydride cell or a lithium cell.

Other features become apparent from the following description of preferred examples. It should be explicitly emphasized here that all those optional aspects of the device which are described herein can each be realized independently or in combination with one or more of the other described optional aspects. The following description of preferred examples serves only to explain my cells and methods and to allow them to be better understood and should in no way be understood as limiting.

### DETAILED DESCRIPTION

FIG. 1 shows a partially cutaway view of a button cell 100. It comprises a housing consisting of the cell cup 101, the cell cover 102, and the seal 103. The cell cover has a sleeve 104 which is divided into a single-walled section 105 and an adjoining circumferential double-walled opening edge with a U-shaped cross-section 106. The latter was formed by bending the cut edge 107 radially outward.

It can be seen that the double-walled opening edge with a U-shaped cross-section 106 is drawn radially inward so that the external diameter of the sleeve 104 in the region of the double-walled opening edge 106 does not exceed the external diameter of the sleeve in the single-walled region 105. As a result of the drawing-in, the sleeve 104 has, immediately below the double-walled opening edge 106, a notch 108 in which the external diameter of the sleeve 104 of the cell cover has a minimum value. This notch 108 can be used to connect the cell cup 101 and the cell cover 102 together by a positive locking connection.

The seal 106 encloses the double-walled opening edge 106 of the cell cover. Furthermore, it covers the outside of the sleeve 104 completely, in particular also the complete single-walled section 105 of the cell cover. It is drawn into the intermediate region, which takes the form of a shoulder, between the sleeve and the base of the cell cover.

FIG. 2 shows an enlarged portion of the cutaway region in FIG. 1. The notch 108 running below the cut edge 107 can be seen. The indentation 111 engages in this notch. The indentation 111 is formed by radially drawing in the double-walled opening edge 106. The cut edge 110 of the cell cup 101 itself is bent radially outward.

The button cell 100 shown is a zinc-air button cell. The air cathode 112 is laid inside the cell cup 101. The zinc anode, which usually essentially completely fills the housing above the air cathode (separated from the latter by a separator), has not been shown for the sake of clarity.

1. A button cell comprising a leaktightly sealed housing consisting of
a cell cup having a base, a circumferential sleeve, an intermediate region connecting the base and the sleeve, and a cut edge at the end,
a cell cover having a base, a circumferential sleeve, an intermediate region connecting the base and the sleeve, and a cut edge at the end, and
a seal,
wherein the cell cover is arranged with the cut edge in front into the cell cup, and the seal between the cell cup and the cell cover is arranged such that it isolates them from each other, and wherein
the sleeve of the cell cover is divided into a single-walled section and an adjoining circumferential double-walled opening edge with a U-shaped cross-section formed by bending the cut edge of the cell cover radially outwardly,
the sleeve of the cell cover has a circumferential notch directly below the circumferential double-walled opening edge, in which its external diameter has a minimum value, and
the sleeve of the cell cup has a circumferential protuberance formed by radial drawing-in which engages in this circumferential notch.

2. The button cell as claimed in claim 1, wherein the protuberance is formed by the radially inward drawn-in cut edge of the cell cup.

3. The button cell as claimed in claim 1, wherein the protuberance is formed by a radial circumferential indentation, arranged below the cut edge, in the sleeve of the cell cup.

4. The button cell as claimed in claim 1, wherein the sleeve of the cell cup has a height which is less than 60% of the height of the button cell.

5. The button cell as claimed in claim 1, wherein an external diameter of the sleeve of the cell cover in the single-walled section does not exceed a maximum external diameter of the sleeve of the cell cup.

6. The button cell as claimed in claim 1, wherein the seal completely covers the outside of the sleeve of the cell cover.

7. A method of producing the button cell as claimed in claim 1, wherein the housing of the button cell is formed from
a cell cup having a base, a circumferential sleeve, an intermediate region connecting the base and the sleeve, and a cut edge at the end,
a cell cover having a base, a circumferential sleeve, an intermediate region connecting the base and the sleeve, and a cut edge at the end, and
a seal,
by the seal being applied to the sleeve of the cell cover and the cell cover is then inserted with the cut edge in front into the cell cup,
wherein
the sleeve of the cell cover has a single-walled section and an adjoining circumferential double-walled opening edge with a U-shaped cross-section formed by radially bending the cut edge of the cell cover outwardly and, directly below the double-walled opening edge, a circumferential notch in which its external diameter has a minimum value, and
the sleeve of the cell cup has a circumferential protuberance formed by radial drawing-in which engages in this notch when the cell cover is inserted into the cell cup, or such a protuberance is formed by radial drawing-in after the cell cover has been inserted into the cell cup.
